(19) United States
(12) Patent Application Publication
(10) Pub. No.: US 2007/0278254 A1
(43) Pub. Date: Dec. 6, 2007

(54) Dispensing closure with selectable large or small dispensing openings

(75) Inventor: John Wisniewski, Wauwatosa, WI (US)

Correspondence Address: WOOD, PHILLIPS, KATZ, CLARK & MORTIMER, 500 W. MADISON STREET, SUITE 3800, CHICAGO, IL, 60661, US

(73) Assignee: SEAQUIST CLOSURES FOREIGN, INC.

(21) Appl. No.: 11/445,527

(22) Filed: Jun. 2, 2006

(51) Int. Cl. B67D 3/00; A47G 19/24

(52) U.S. Cl. 222/480; 222/565

(57) ABSTRACT

A dispensing structure is provided for a container that has an opening from which a product can be dispensed. The structure includes a body for extending around the container opening. The body defines an upper deck and also defines a recessed lower deck defining at least a portion of a first dispensing aperture communicating with the container opening. An intermediate member defines at least one second dispensing aperture that is smaller than the first dispensing aperture. The intermediate member is pivotable about an axis between a closed position and an open position. In the closed position, the intermediate member has a top surface that is preferably generally flush with the upper surface of the upper deck. A lid is pivotable on the closure body about a different axis and can be closed to occlude the second dispensing aperture.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

This invention relates to a system for dispensing product from a container. The invention is more particularly related to a system that facilitates removal of a product through either one of two different dispensing orifices.

### BACKGROUND OF THE INVENTION AND TECHNICAL PROBLEMS POSED BY THE PRIOR ART

A variety of packages, including dispensing packages or containers, have been developed for particulate food products, such as herbs, spices, granular salt, etc., as well as other materials. Such containers typically have an open upper end on which is mounted a closure.

U.S. Pat. No. 5,975,368 and U.S. Pat. No. 6,382,476 each discloses a type of dispensing closure for a dispensing container which has a body defining at least one relatively large access aperture. An intermediate member defining at least one smaller dispensing hole is hingedly mounted for being pivoted between (1) a first position over the body large aperture(s), and (2) a second position away from the large aperture(s). A lid is hinged to the body for pivoting between an open position and a closed position over the intermediate member when the intermediate member is in its second position over the large aperture(s) in the closure body. In the closed position, the lid sealingly occludes the smaller aperture(s) in the intermediate member. When the lid is open, the intermediate member can be moved to its second position spaced away from the larger aperture(s) in the closure body to permit access to, or pouring of, the product through the larger aperture(s) in the closure body. When the lid is open and the intermediate member is in its first position over the larger aperture(s) in the closure body, the container contents can be dispersed through the intermediate member smaller aperture(s).

While dispensing closures with the above-described designs can function well when used in the applications for which they are intended, it would be desirable to provide an improved dispensing system for containers providing certain operational advantages and accommodating certain design features and variations.

It would be particularly desirable to provide a dispensing structure having a body with a first dispensing aperture, a lid, and an intermediate member, wherein the intermediate member defines at least one smaller dispensing aperture and can fit on the closure body with improved support and engagement.

It would also be advantageous if such an improved dispensing structure could be provided with an intermediate member wherein the intermediate member and body can provide a dispensing configuration that accommodates cleaning and that is aesthetically pleasing.

It would also be beneficial if such an improved dispensing structure could optionally be incorporated in a molded, one-piece, unitary article.

Further, it would be desirable if such an improved dispensing structure could be provided with a design that would accommodate efficient, high-quality, large volume manufacturing techniques with a reduced product reject rate.

### SUMMARY OF THE INVENTION

The present invention provides an improved dispensing structure which can accommodate designs having at least one or more of the above-discussed benefits and features.

According to one aspect of the present invention, a dispensing system or structure is provided for a container that has an opening to the container interior. The dispensing structure includes a body that is either a separate structure for attaching to, and extending from, the container at the container opening or is a unitary extension of the container at the opening. The body has (1) an upper deck, and (2) a lower deck that (a) is recessed below the upper deck, and (b) has at least one support portion adjacent to a first dispensing aperture defined in said body for communicating with the container opening.

The dispensing structure also includes an intermediate member that (1) has a generally planar configuration with (a) a bottom surface adapted to be seated on at least part of the body lower deck support portion, and (b) a top surface, and (2) defines at least one second dispensing aperture that is smaller than the first dispensing aperture and that extends between said bottom surface and said top surface.

The dispensing structure also includes a first hinge connecting the intermediate member to the body at a first location for pivoting movement between (1) a closed position over the body to locate the second dispensing aperture over the first dispensing aperture and block a peripheral portion of the first dispensing aperture which extends peripherally beyond the second dispensing aperture, and (2) an open position away from the closed position to permit complete access to the first dispensing aperture

The dispensing structure also includes a lid, and a second hinge connecting the lid to the body at a second location spaced from the first location for pivoting movement between (1) a lid closed position over the second dispensing aperture for engaging the intermediate member when the intermediate member is in its closed position whereby the second dispensing aperture is occluded, and (2) a lid open position away from the lid closed position to permit access to the second dispensing aperture when the intermediate member is in the closed position.

Numerous other advantages and features of the present invention will become readily apparent from the following detailed description of the invention, from the claims, and from the accompanying drawings.

### BRIEF DESCRIPTION OF THE DRAWINGS

In the accompanying drawings that form part of the specification, and in which like numerals are employed to designate like parts throughout the same,

FIG. 1 is a fragmentary, perspective view of a preferred embodiment of a dispensing structure of the present invention in the form of a fully closed closure which can be removably mounted on a container (a fragmentary portion of which is shown);

FIG. 2 is a view similar to FIG. 1, but in FIG. 2 the closure lid is shown open;

FIG. 3 is a view similar to FIG. 2, but in FIG. 3 the container has been omitted, and the closure intermediate member is shown opened to a substantially vertical orientation.

FIG. 4 is a fragmentary, cross-sectional view taken generally along the plane 4-4 in FIG. 1;

FIG. 5 fragmentary, is a cross-sectional view taken generally along the plane 5-5 in FIG. 2; and

FIG. 6 is a cross-sectional view taken generally along the plane 6-6 in FIG. 3.

### DESCRIPTION OF THE PREFERRED EMBODIMENT

While this invention is susceptible of embodiment in many different forms, this specification and the accompanying drawings disclose only one specific form as an example of the invention. The invention is not intended to be limited to the embodiment so described, however. The scope of the invention is pointed out in the appended claims.

For ease of description, the dispensing structure of this invention is described in the normal (upright) operating position, and terms such as upper, lower, horizontal, etc., are used with reference to this position. It will be understood, however, that the dispensing structure of this invention may be manufactured, stored, transported, used, and sold in an orientation other than the position described.

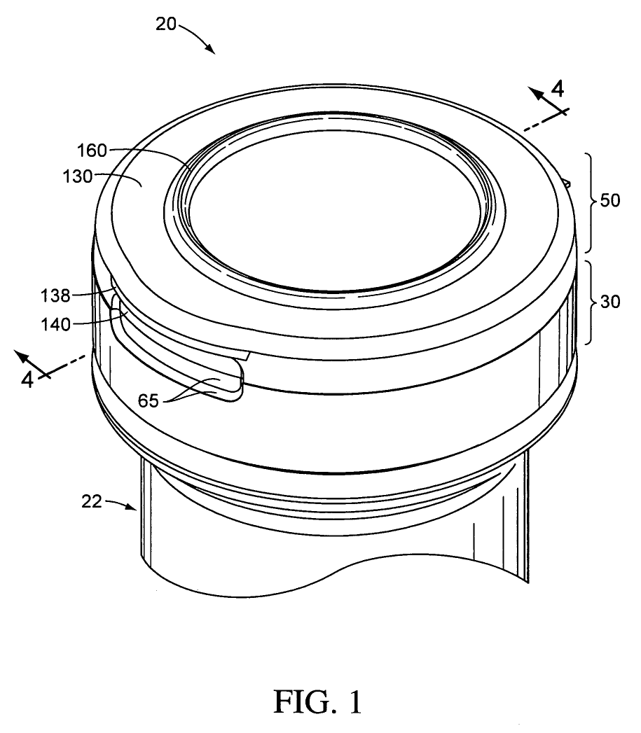

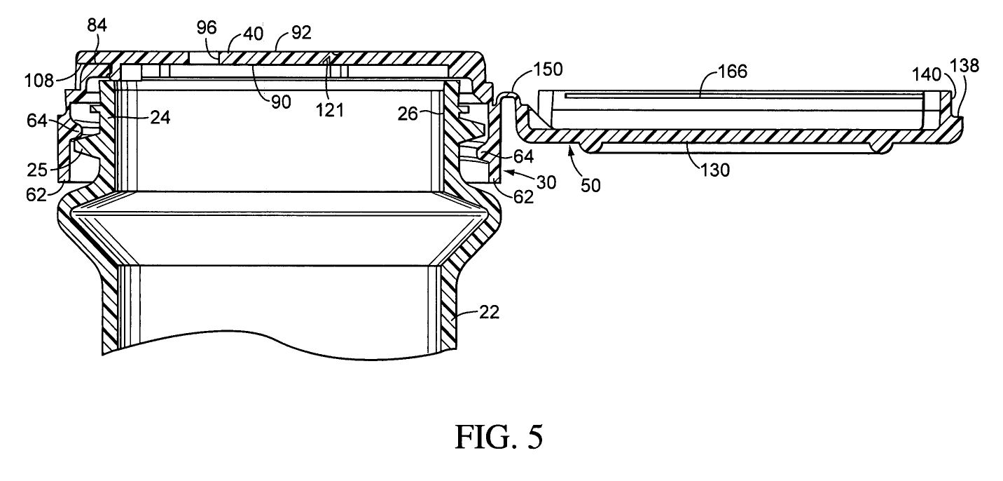

A presently preferred embodiment of a dispensing structure or system of the present invention is illustrated in FIGS. 1-6 and is designated generally therein by reference number 20 in FIG. 1. In the preferred embodiment illustrated, the dispensing structure 20 is provided in the form of a closure 20 which is adapted to be mounted on a container 22. The body of the container 22 can have any suitable configuration with an upwardly projecting peripheral wall or neck 24 (FIG. 5) which may have a different cross-sectional shape than the container body. The neck 24 can have a suitable connection or attachment structure, such as a thread 25 (FIG. 5).

The container 22 would typically contain a liquid material, powdered material, granular material, or other particulate material. The container 22 may have a rigid wall or walls or may have a somewhat flexible wall or walls. The container 22 defines an opening 26 (FIG. 5), typically at the upper end of the container neck 24.

Although the container 22, per se, need not necessarily form a part of the present invention, per se, it will be appreciated that the dispensing structure or system of the present invention may be provided as a unitary portion, or extension, of the top of a container. However, in the preferred embodiment illustrated, the dispensing structure 20 is a separate article (i.e., a closure) which is adapted to be mounted to a previously manufactured container 22 which has an opening 26 to the container interior.

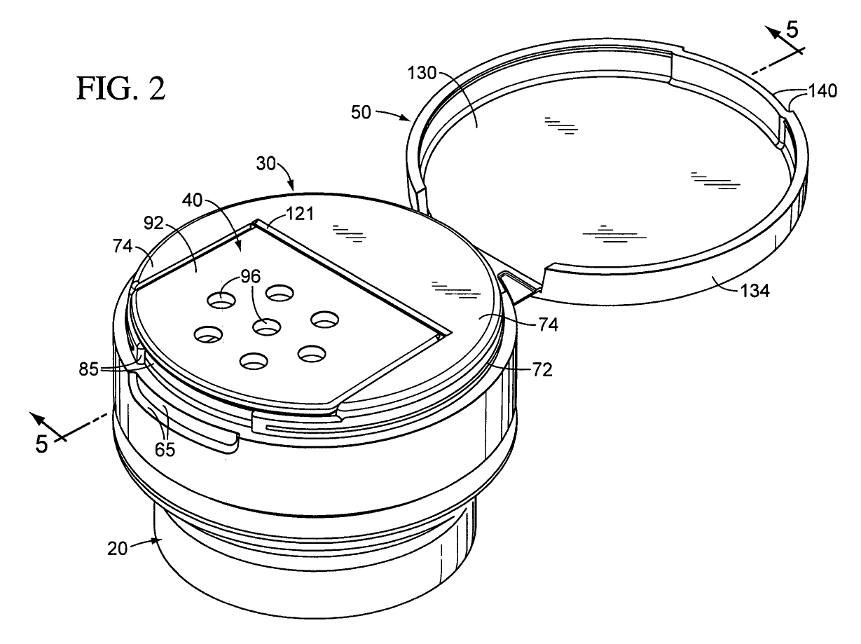

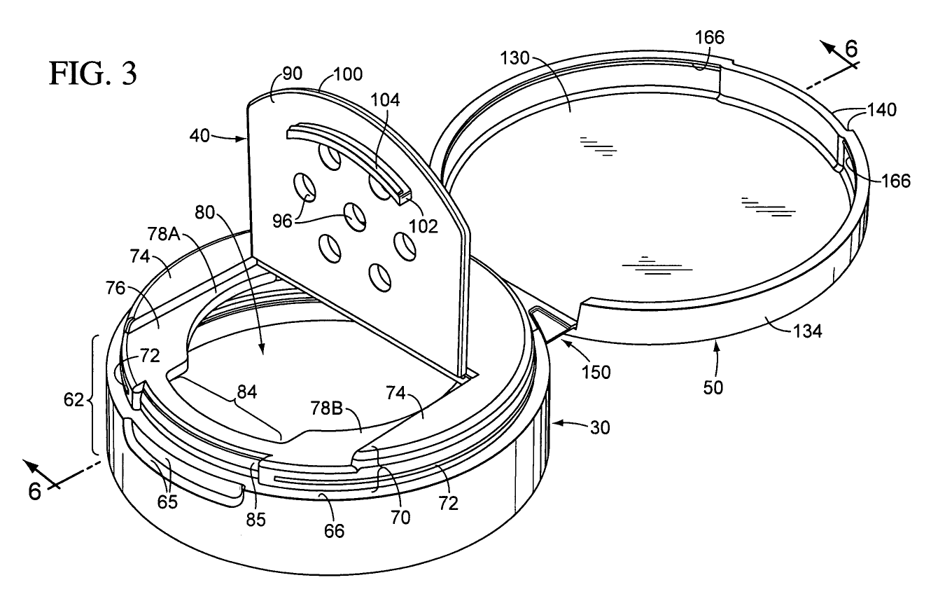

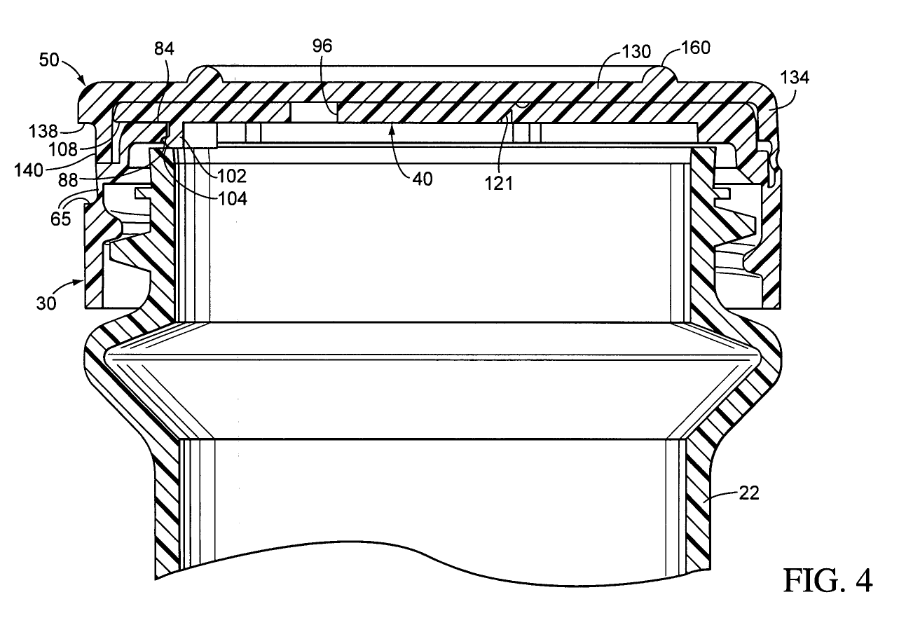

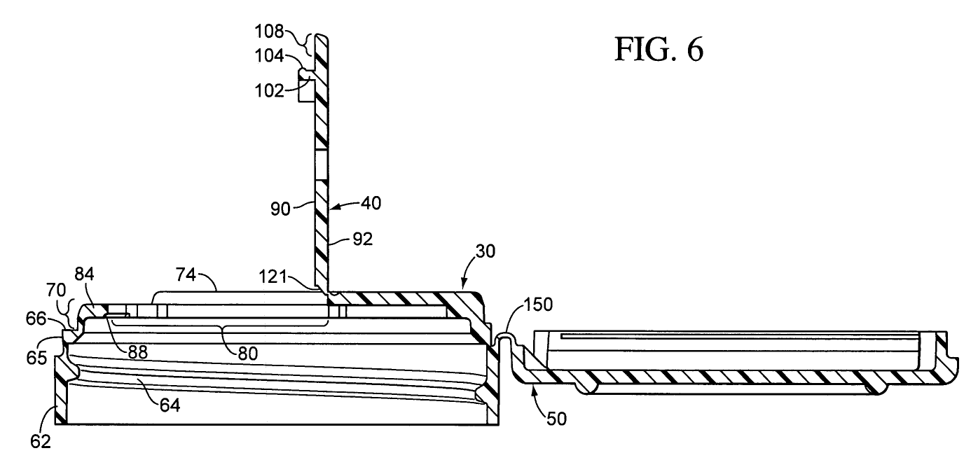

As shown in FIGS. 3 and 6, the preferred embodiment closure or dispensing structure 20 of the present invention includes a base portion or body 30, an intermediate member 40, and a lid 50. In the preferred embodiment illustrated, the intermediate member 40 and lid 50 are each hingedly connected to the body 30 by means described in detail hereinafter. This accommodates movement of the lid 50 from a closed position (FIG. 1) to an open position (FIGS. 2 and 4) while maintaining the lid 50 attached to the body 30, and this also permits movement of the intermediate member 40 from a closed position (FIGS. 2 and 4) to an open position (FIGS. 3 and 6) while maintaining connection of the body to both the intermediate member 40 and lid 50.

As illustrated in FIGS. 5 and 6, in the preferred embodiment of the dispensing structure 20, the body 30 may be characterized as having or defining a skirt 62 for removably or non-removably receiving the upper end of the container 22. The skirt 62 interior includes suitable connecting means, such as a conventional thread 64 (FIG. 5) adapted to be threadingly engaged with a mating container thread 25. The closure body 30 could also be attached to the container 22 with either a conventional, dual snap-fit bead engagement or a conventional, mating bead and groove engagement (neither of which is illustrated).

Also, the closure body 30 could be permanently fixed to the container 22 by means of induction melting, ultrasonic melting, gluing, or the like, depending upon the materials used for the closure body 30 and container 22. As previously mentioned, the closure body 30 could also be formed as a unitary part, or extension, of the container 22.

The front exterior of the skirt 62 includes a thumb recess 65. Above the recess 65, as illustrated in FIG. 3, the top of the closure body 30 defines a peripheral deck 66. A platform 70 (FIGS. 3 and 6) extends upwardly from the shoulder 66. The sidewall of the platform 70 has two lid latching beads 72, one on each side of the closure body 30. The latching beads 72 do not extend all the way around to the front or rear of the closure body, and hence the latching beads 72 are not visible in the cross-sectional views shown in FIGS. 4, 5, and 6.

As can be seen in FIG. 3, the platform 70 defines an upper deck 74 and a lower deck 76. The lower deck 76 is recessed below the upper deck 74. The lower deck 76 has two spaced-apart lateral support portions 78A and 78B which define between them a first dispensing aperture 80 (FIG. 3) for communicating with the container opening. The platform 70 can be characterized as a portion of the closure body that, when the closure body is mounted on the container 22, extends over the container opening 26 (FIG. 5) to define the first dispensing aperture 80 (FIG. 3) that is smaller than the container opening 26.

The body lower deck 76 also has a front support portion 84 (FIG. 3) which joins the two spaced-apart lateral support portions 78A and 78B. The closure body front support portion 84 defines a resilient lip 88 with a lower edge adjacent the front of the first dispensing aperture 80. The closure body front support portion 84 also defines a front recess 85 (FIG. 3) which is open forwardly to the closure body shoulder 66 above the closure body thumb recess 65. The front support portion 84 and the two spaced-apart lateral support portions 78A and 78B preferably lie in a common plane for supporting the intermediate member 40 when the intermediate member 40 is in the closed position (FIGS. 2 and 4).

As can be seen in FIGS. 3 and 6, the intermediate member 40 has a generally planar configuration with a bottom surface 90 that is adapted to be seated on the body deck lower lateral support portions 78A and 78B, and on the closure body front support portion 84 when the intermediate member 40 is in the closed position (FIGS. 2 and 4).

The intermediate member 40 has a top surface 92 (FIGS. 2 and 6) which is preferably adapted to be generally flush with the upper surface of the closure body upper deck 74 when the intermediate member 40 is in the closed position (FIG. 2).

The intermediate member 40 defines at least one second dispensing aperture that is smaller than the first dispensing aperture 80, and in the preferred embodiment, the intermediate member 40 defines a plurality of spaced-apart second dispensing apertures 96 (FIGS. 2 and 3) extending between the bottom surface 90 and the top surface 92.

When the intermediate member 40 is in the closed position (FIG. 2), the second dispensing apertures 96 are disposed over the closure body first dispensing aperture 80. In the presently preferred illustrated embodiment, each second dispensing aperture 96 has a generally circular flow area, and the intermediate member 40 defines a partially circular edge 100 (FIG. 3) at the front end of the intermediate member 40.

As can be seen in FIG. 3, the intermediate member 40 has a flange 102 projecting from the bottom surface 90, and the flange 102 includes an outer snap bead 104 for engaging the lower edge of the closure body resilient lip 88 (FIG. 6) when the intermediate member 40 is in the closed position (FIG. 4). This effects a snap-fit retention of the intermediate member 40 in the closed position.

As can be seen in FIG. 6, the intermediate member 40 also includes an outer front portion 108. When the intermediate member 40 is in the closed position (FIG. 4), the outer front portion 108 overhangs the front edge of the closure body front support portion 84. When the lid 50 is opened (as shown in FIGS. 2 and 5), the overhanging outer front portion 108 of the intermediate member 40 can be engaged by a user's finger, or thumb, to assist in lifting the intermediate member 40 upwardly to the open position (FIGS. 3 and 6).

The intermediate member 40 is connected with a first hinge 121 (FIGS. 2, 5, and 6) to the closure body upper deck 74 to accommodate pivoting movement of the intermediate member 40 between the closed position (FIGS. 2 and 5) and the open position (FIGS. 3 and 6). The hinge 121 is preferably a unitary molded living hinge defined by a reduced thickness region of material as can be seen in FIG. 5.

Opening of the intermediate member 40 permits complete access to the first dispensing aperture 80 as can be seen in FIGS. 3 and 6. A larger quantity of product can be poured out through the first dispensing aperture 80 (or scooped out of the container through the first dispensing aperture 80) when the intermediate member 40 is in the open position compared to the amount of material that can be poured out of the smaller apertures 96 when the intermediate member 40 is in the closed position (FIGS. 2 and 5).

As can be seen in FIGS. 2 and 5, when the lid 50 is open, and the intermediate member 40 is in the closed position, the top surface 92 of the intermediate member 40 is preferably generally flush with the adjacent top surface of the closure body upper deck 74. This provides an aesthetically pleasing arrangement. This arrangement accommodates ease of pouring of the product through the intermediate member apertures 96 without obstructions. Further, the top surface 92 of the intermediate member 40 and the adjacent surface of the top of the closure body upper deck 74 can be readily cleaned.

When the intermediate member 40 is closed (FIGS. 1, 2, 4, and 5), the lateral portions of the intermediate member bottom surface 90 confront, and can be effectively sealingly engaged with, the upwardly facing surfaces of the closure body lateral support portions 78A and 78B, and the top surface of the closure front support portion 84 (FIG. 3). The intermediate member 40 effectively supported on three sides by the closure body support portions and is supported on the fourth side by the hinge 121 connecting the intermediate member 40 to the closure body 30. The intermediate member 40 can be conveniently molded with a slide as part of the closure 20 to accommodate the various features.

As can be seen in FIGS. 2 and 5, the lid 50 includes a central portion or deck 130 and extending peripheral skirt 134. Projecting outwardly from the front portion of the skirt 134 is a thumb lift 138 (FIGS. 1 and 5). Adjacent the thumb lift 138 is a recess or notch 140 for accommodating the user's thumb or finger.

The lid 50 may be completely separate from the closure body 30. However, in the preferred embodiment illustrated, the lid 50 is preferably connected to the closure body 30 with a suitable hinge 150 (FIGS. 3 and 6). One suitable hinge is the snap-action hinge 100 disclosed in U.S. Pat. No. 6,321,923. Preferably, such a snap-action hinge 150 provides a bi-stable action for maintaining the lid 50 in a closed position (FIGS. 1 and 4) or in an open position (FIGS. 2, 3, 5, and 6).

The exterior of the deck 130 includes an upwardly projecting stacking ring 160 (FIGS. 1 and 4) for engaging a mating ring or groove on the bottom of a container (not shown) when another container is stacked on top of the closure.

On the inside of the closure lid skirt 130, there are two latch beads 166 (FIG. 3)—one on each side of the lid 50. Each lid latch bead 166 is adapted to engage beneath the closure body latching beads 72 (FIG. 2) when the lid 50 is closed (FIGS. 1 and 4).

When the lid 50 is in the closed position (e.g., FIGS. 1 and 4), the engagement between the lid latching beads 166 and the closure body latching beads 72 (visible in FIGS. 2 and 3) retain the lid 50 in the closed position unless sufficient force is exerted by the user on the lid thumb lift 138 (FIG. 1) to cause disengagement of the lid latching beads 166 from the closure body latching beads 72.

The dispensing structure 20 is easily used. A user typically encounters the dispensing structure 20 in an initially closed condition (FIGS. 1 and 4) mounted on a container 22. The user may initially lift the lid 50 by applying an upward force with a finger or thumb to the lid lift tab 138. The lid 50 may be rotated to a fully opened position as shown in FIG. 2 to expose the dispensing apertures 96 of the intermediate member 40. Instead of immediately dispensing product from the container 22 through the dispensing apertures 96, the user may wish to instead initially lift the intermediate member 40 by its front portion 108 (FIG. 5) to an opened position as illustrated in FIG. 3.

The closure body first dispensing aperture 80 may be relatively large, either to provide access to the interior of the container 22 for a spoon or other implement, or to accommodate pouring of a large stream of product through the dispensing aperture 80.

If it is desired to dispense a smaller flow of product, such as a small diameter discharge streams of product, the intermediate member 40 can be initially left in the closed position (FIG. 2), or returned from the open position (FIG. 3) to the closed position (FIG. 2). When the intermediate member 40 is in the closed position as shown in FIG. 2, the product can be discharged from the container 22 through the intermediate member dispensing apertures 96 which may be substantially smaller than the closure body dispensing aperture 80. When the intermediate member 40 is in the closed position illustrated in FIG. 2, the periphery of the intermediate member 40 is sealingly engaged with the closure body over the larger dispensing aperture 80.

When the user is finished dispensing product through the dispensing closure 20, the lid 50 may be returned to the closed position as illustrated in FIGS. 1 and 4. If both the intermediate member 40 and lid 50 were in an open position, then both the intermediate member 40 and the lid 50 must be returned to the closed position. In the closed position, the lid 50 preferably is sealingly engaged with the closed intermediate member 40 to sealingly occlude the second dispensing apertures 96, and thus prevent flow out of the dispensing structure or closure 20. Alternatively, or in addition, the lid 50 could be provided with projections or spuds to enter into the apertures 96 to occlude the apertures.

It is presently contemplated that many applications employing the dispensing structure 20 will be most conveniently realized by molding the dispensing structure 20 from suitable thermoplastic material or materials. In the preferred embodiment illustrated, the body 30, intermediate member 40, hinge 121, lid 50, and hinge 150 are molded together as a unitary structure from a suitable thermoplastic material, such as polypropylene.

It will also be appreciated that various retention structures, instead of the ones described above, may be provided for releasably retaining the intermediate member 40 and the lid 50 in the closed positions. Such various retention structures can include, for example, a suitable snap-fit engagement between a very small rib on one part and a mating groove on the other part (not illustrated).

It will also be appreciated that the dispensing structure 20 can be readily designed to incorporate appropriate tamper-evident features and/or child-resistant features. Such features may be incorporated within the structure of the closure body and lid and/or may include overcap structures or shrink film systems (not illustrated).

It will also be appreciated that the dispensing structure of the present invention need not be provided as a separate closure for a container. The closure body, such as closure body 30, could instead be molded as a unitary part of a container. A container (having a peripheral wall forming an end that defines a container opening) could be molded with a body portion extending radially inwardly from the container peripheral wall over the container end opening so as to form a unitary part of the container end and so as to define the first dispensing aperture, similar to the first dispensing aperture 80 illustrated in FIG. 3, that would be smaller than the container end opening.

In the embodiment illustrated in FIGS. 1-6, the dispensing structure 20 is in the form of a closure which can be removably attached to a container 22 by threaded engagement. It will be appreciated that other removable or non-removable attachment systems may be employed as discussed in detail above.

It should be understood that either the body first dispensing aperture 80 or the intermediate member second dispensing apertures 96 could include one or more pressure-openable valves, such as, for example, any of the slit-type valves disclosed in the U.S. Pat. No. 5,839,614, or modifications of such valves.

It will be readily apparent from the foregoing detailed description of the invention and from the illustrations thereof that numerous variations and modifications may be effected without departing from the true spirit and scope of the novel concepts or principles of this invention.

What is claimed is:

1. A dispensing structure for a container that has an opening to the container interior, said dispensing structure comprising:
a body that is either a separate structure for attaching to, and extending from, said container at said container opening or is a unitary extension of said container at said opening, said body having (1) an upper deck, and (2) a lower deck that (a) is recessed below said upper deck, and (b) has at least one support portion adjacent to a first dispensing aperture defined in said body for communicating with said container opening;
an intermediate member that (1) has a generally planar configuration with (a) a bottom surface adapted to be seated on at least part of said body lower deck support portion, and (b) a top surface, and (2) defines at least one second dispensing aperture that is smaller than said first dispensing aperture and that extends between said bottom surface and said top surface;
a first hinge connecting said intermediate member to said body at a first location for pivoting movement between (1) a closed position over said body to locate said second dispensing aperture over said first dispensing aperture and block a peripheral portion of said first dispensing aperture which extends peripherally beyond said second dispensing aperture, and (2) an open position away from said closed position to permit complete access to said first dispensing aperture;
a lid; and
a second hinge connecting said lid to said body at a second location spaced from said first location for pivoting movement between (1) a lid closed position over said second dispensing aperture for engaging said intermediate member when said intermediate member is in its closed position whereby said second dispensing aperture is occluded, and (2) a lid open position away from said lid closed position to permit access to said second dispensing aperture when said intermediate member is in said closed position.

2. The dispensing structure in accordance with claim 1 in which
said dispensing structure is a closure for an end of said container wherein the container end defines said container opening; and
said closure is a unitary structure that includes said body, said first hinge, said intermediate member, said lid, and said second hinge all molded from a thermoplastic material.

3. The dispensing structure in accordance with claim 2 in which
said closure is an article that is separate from said container; and
said body is removably attachable to said container end over said container opening.

4. The dispensing structure in accordance with claim 2 in which
said dispensing structure is adapted to be mounted on a container that includes a peripheral wall forming said end that defines said container opening; and
said body, when mounted on said container, includes a portion that (1) extends radially inwardly relative to said container peripheral wall, and (2) extends over said container opening to define said first dispensing aperture that is smaller than said container opening.

5. The dispensing structure in accordance with claim 1 in which said at least one second dispensing aperture has a generally circular flow area.

6. The dispensing structure in accordance with claim 1 in which said intermediate member has a partially circular edge at a location generally diametrically opposite from said first hinge.

7. The dispensing structure in accordance with claim 1 in which said body and lid are molded together as a unitary structure with said second hinge.

8. The dispensing structure in accordance with claim 1 in which said body and intermediate member are molded together as a unitary structure with said first hinge.

9. The dispensing structure in accordance with claim 1 in which
said closure body includes a resilient lip with a lower edge adjacent the front of said first dispensing aperture; and
said intermediate member includes a flange with a snap bead for engaging said resilient lip lower edge on said closure body.

10. The dispensing structure in accordance with claim 1 in which
said body lower deck has a front support portion joining said two spaced-apart lateral support portions;
said front support portion and said two spaced-apart lateral support portions define upwardly facing surfaces lying in a common plane for supporting said intermediate member;
said front support portion defines an outer front edge;
said lid includes a thumb lift; and
said intermediate member includes an outer front portion overhanging said front edge of said body front support portion when said intermediate member is in said closed position.

11. The dispensing structure in accordance with claim 1 in which said top surface of said intermediate member is sealingly engaged by said lid when said lid is in said lid closed position.

12. The dispensing structure in accordance with claim 1 in which said body has two of said support portions, and said two support portions are spaced apart laterally so that one of said support portions is on one side of said first dispensing aperture and so that the other of said support portions is on another side of said first dispensing aperture.

13. The dispensing structure in accordance with claim 1 in which said upper deck has an upper surface and in which said intermediate member top surface is adapted to be generally flush with said upper deck upper surface.
